(19) United States
(12) Patent Application Publication
(10) Pub. No.: US 2026/0364980 A1
(43) Pub. Date: Nov. 19, 2026

(54) SEALANT SYSTEM

(71) Applicant: Continental Reifen Deutschland GmbH, Hannover (DE)

(72) Inventors: Florian Schlosser, Barsinghausen (DE); Rainer Detering, Neustadt am Rübenberge (DE)

(73) Assignee: Continental Reifen Deutschland GmbH, Hannover (DE)

(21) Appl. No.: 19/126,141

(22) PCT Filed: Oct. 20, 2023
(86) PCT No.: PCT/DE2023/200214

§ 371 Date: Apr. 30, 2025

(30) Foreign Application Priority Data
Nov. 2, 2022 (DE) 1020222111591.0

(51) Int. Cl. B60C 25/00; B65D 83/38

(52) U.S. Cl. CPC B60C 25/16; B65D 83/382

(57) ABSTRACT

A sealant system, comprising including: a) a sealant container having a container interior for holding sealant, the container interior is accessible via a container opening, and b) a container closure, which closes the container opening) in a fluidtight manner. The container closure includes a) a first fluid channel extending through the container closure, and which is closed by a first closure layer, and b) a second fluid channel extending through the container closure, and which is closed by a second closure layer. The first closure layer is irreversibly destroyed and forms a first through-opening as the result of a first pressure difference, from 50 to 1000 kPa, acting between the sides of the first closure layer. The second closure layer forms a second through-opening as the result of a second pressure difference, from 50 to 1000 kPa, acting between the sides of the second closure layer.

### DESCRIPTION

The invention relates to a sealant system, to a container closure for the fluidtight closure of a container opening of a sealant container in a corresponding sealant system, and to a method for producing a corresponding sealant system or a corresponding container closure. Also disclosed are a puncture repair kit and a method for using a corresponding puncture repair kit to seal a damaged vehicle tire.

In many areas of technology, such as in the tire and vehicle industry, sealants are often used to seal leaking components. In most cases, sealants are supplied in viscous form in what are known as sealant systems and develop their sealing effect only after leaving this sealant system, e.g. through contact with air and/or the substrate to be sealed. Particularly in the tire and vehicle industries, the use of sealant systems is widespread, e.g. in the context of puncture repair kits for the at least temporary repair of damaged vehicle tires.

Such sealant systems for storing sealants are often subject to particularly demanding requirements since, on the one hand, they must enclose a sealant to be stored in such a way that it does not cure prematurely and, accordingly, should reliably prevent accidental escape of sealant and, on the other hand, when in use, must enable rapid and simple supply, which it must be possible to accomplish, particularly in the case of puncture repair kits, even by non-experts and/or without suitable tools.

Accordingly, sealant systems must be closed fluidtightly after filling with sealant in order to protect the sealant from environmental influences, in particular also in the case of jolting and vibration. Only during use of the sealant system by a user is the closure of the sealant system opened by suitable measures in order to discharge the sealant, this generally being promoted or effected by the application of an external pressure and forcing the sealant out of the sealant system.

Various mechanisms are known in the prior art for closing sealant systems. Disclosures in this respect can be found in EP 280701881A1 , EP 2030768A1 , DE 20113129U1 , DE 29716453 U1 and DE 10106468A1 , for example. Thus, for example, seals are known for closing the sealant bottles, in particular seals made of aluminum, which, before use, must either be removed manually, for example, or can be opened by connecting the sealant system to external components by means of cutting devices integrated therein. In addition, the prior art discloses separate seal elements for use in sealant systems, which can be integrated into cap elements and, when subjected to pressure, can be released and allow fluid to pass through.

Even if, in many cases, the solutions known from the prior art can satisfy the usage requirements on sealant systems, at least to a large extent, they are also felt to be disadvantageous in practice, particularly from a manufacturing and handling point of view.

The simpler solutions, in particular, are often limited to simply closing the sealant container, and therefore the functionality required in use for discharging the sealant has to be provided by separate devices, e.g. by a corresponding fluid line system with coaxial lines.

Moreover, where the sealant container is closed by a seal, the person skilled in the art must also in most cases carefully match the material of the seal and the material of the sealant container as well as the adhesives that may be used for attachment in order to be able to ensure both fluidtight closure and, where required, safe opening, and therefore the possible choices of material are usually restricted. Furthermore, in some cases, a special device, e.g. a discharge aid with a cutting tool, is required in turn for efficiently cutting open the seal.

On the other hand, closure of the sealant system by means of separate seal elements in the container closure generally requires particularly precise manufacture of the components in order to achieve a fluidtight form fit between the seal element and the container cap, which is maintained, in particular, also in the case of jolting, vibration or shocks. In addition, there is also always a risk, in the case of a separate seal element that is, for example, forced open by compressed air, that the lines will be clogged in such a way that sealant is partially or even completely prevented from emerging from the sealant system.

In the case of most solutions known from the prior art, for example using sealing or separate seal elements, additional production steps are furthermore necessary to implement the corresponding solutions.

The primary object of the present invention was that of eliminating or at least mitigating the above-described disadvantages of the prior art.

In particular, it was the object of the present invention to specify a sealant system and an associated container closure, the production of which should be possible in a particularly time-and cost-efficient manner, wherein the mode of production should ideally promote the sealing effect, wherein, in particular, a reduction in the work steps required should be achieved. In this context, it was a desirable target that the manufacture of the sealant system to be specified and of the associated container closure as well as the connection of the container closure to the sealant container should be simplified in comparison with the prior art, wherein, in particular, the number of components used was to be minimized and the range of materials that could be used was to be increased.

It was an object of the present invention that the sealant system to be specified and the associated container closure should have an advantageous fluidtightness, even under external mechanical loads such as vibration and shocks, and, as a result, should enable reliable storage of corresponding sealants even under challenging environmental conditions, e.g. in the trunk of a vehicle.

In addition, it was an object of the present invention that the sealant system to be specified should be capable of being used efficiently in methods for sealing a damaged vehicle tire, wherein, in particular, the requirements on the devices required for this purpose were to be reduced, in particular in respect of the need for cutting devices for opening the sealant system or complex fluid line systems.

It was a further object of the present invention that it should be possible, in the sealant system to be specified and in the container closure to be specified, as far as possible to avoid unwanted clogging of fluid lines during use in the sealing process.

In addition, it was an object of the present invention to specify an advantageous method for producing a corresponding sealant system and an associated container closure. At the same time, it was a desirable target that it should be possible in a particularly simple way to implement checking of the leaktightness of the components as part of the method to be specified.

Moreover, it was a secondary object of the present invention to provide a puncture repair kit comprising one or more corresponding sealant systems as well as a method for sealing a damaged vehicle tire by means of such a puncture repair kit.

The inventors have now found that the objects described above can surprisingly be achieved if a container closure in a sealant system is embodied in such a way that the sealant container of the sealant system is closed in a fluidtight manner by means of two fluid channels, each provided with closure elements, in the container closure, if the closure elements are each designed in such a way that they are broken open when a specific pressure difference is applied, such that passage of fluid through the respective fluid channel is enabled, as defined in the claims.

It is thereby advantageously possible to obtain a sealant system which can be produced in a particularly time-and cost-efficient manner, wherein the sealant system can be closed in a particularly simple and, at the same time, reliable manner by the corresponding container closure, wherein unwanted clogging of lines can be reliably prevented. At the same time, in a synergistic way, the container closure enables efficient fluid guidance, by means of which the design requirements on the devices used in the method for sealing a damaged vehicle tire can be considerably reduced. Moreover, the sealant system can be reliably opened by means of a fluid-mediated pressure application, thus making it possible, in particular, also to dispense with external cutting devices.

The above-stated objects are accordingly achieved by means of the subject matter of the invention as defined in the claims. Preferred design embodiments according to the invention are derived from the dependent claims and from the explanations hereunder.

In particularly preferred embodiments, embodiments that are referred to as preferred hereunder are combined with features of other embodiments that are referred to as preferred. Combinations of two or more of the embodiments that are referred to as particularly preferred hereunder are thus most particularly preferred. Likewise preferred are embodiments in which a feature of one embodiment that is referred to as preferred to a certain extent is combined with one or more further features of other embodiments that are referred to as preferred to a certain extent. Features of preferred container closures, puncture repair kits and methods are apparent from the features of preferred sealant systems.

The invention relates, in particular, to a sealant system, in particular a sealant system for use in sealing vehicle tires, comprising:
a) a sealant container, comprising a container interior for holding sealant, wherein the container interior is accessible via a container opening, and
b) a container closure,
wherein the container closure closes the container opening in a fluidtight manner,
wherein the container closure comprises a first fluid channel extending through the container closure, wherein the first fluid channel is closed by a first closure layer, by which fluid is prevented from escaping out of the container opening through the first fluid channel,
wherein the container closure comprises a second fluid channel extending through the container closure, wherein the second fluid channel is closed by a second closure layer, by which fluid is prevented from escaping out of the container opening through the second fluid channel,
wherein the container closure is configured such that the first closure layer is irreversibly destroyed and forms a first through-opening, which makes it possible for fluid to pass through the first fluid channel, as the result of a first pressure difference, in the range from 50 to 1000 kPa, acting between the sides of the first closure layer, and
wherein the container closure is configured such that the second closure layer forms a second through-opening, which makes it possible for fluid to pass through the second fluid channel, as the result of a second pressure difference, in the range from 50 to 1000 kPa, acting between the sides of the second closure layer.

The fundamental mode of operation of sealant systems and the use thereof in puncture repair kits are known to those skilled in the art on the basis of their expert knowledge. Accordingly, those skilled in the art will understand that a sealant system according to the invention must be suitable both for fluidtight storage and for subsequent dispensing of sealants, wherein, as regards the fundamental configuration, the sealant system can be adapted by those skilled in the art to the requirements of the sealant to be held, e.g. in respect of the material of the sealant container.

For holding sealant, the sealant system according to the invention comprises a sealant container having a container interior which is accessible via a container opening and which is sometimes also referred to as a sealant bottle. An appropriate sealant system according to the invention for substantially all the embodiments in the area of sealing vehicle tires is one wherein the container interior has a volume in the range of from 0.05 to 10 l, preferably in the range of from 0.1 to 5 l, particularly preferably 0.2 to 2.5 l, very particularly preferably 0.2 to 1.25 l.

Those skilled in the art will understand that the sealant does not necessarily have to be part of the above-defined sealant system according to the invention, which may, for example, also be supplied to a sealant manufacturer by a producer as a (re-)fillable storage container. In one particularly preferred embodiment, however, the sealant system according to the invention already contains the sealant, enabling it to be used immediately for sealing vehicle tires. Compositions suitable for use as sealants, in particular for sealing vehicle tires, are known from the prior art to those skilled in the art and are commercially available from various suppliers. Accordingly, a sealant system according to the invention is preferred which additionally comprises in the container interior a sealant, preferably a sealant for sealing damaged vehicle tires. In this context, a damaged vehicle tire is taken to mean, in particular, a vehicle tire with relatively small holes in the tread such as those that may be caused by nails or the like, for example.

A person skilled in the art will understand that, apart from the container opening, the sealant container will in practice be fluidtight in most cases, and therefore viscous sealant or other fluids can enter or escape only via the container opening.

In principle, however, it is at least theoretically possible to equip the sealant container with a plurality of container openings, each of which would then have to be closed. In most cases, however, it is advantageous to provide just a single container opening in order, on the one hand, to increase the stability of the sealant container and to facilitate the production of corresponding containers and, on the other hand, to simplify the fluidtight closure of the container interior. A sealant system according to the invention in which the container interior is accessible via just one container opening is therefore appropriate in most cases.

The sealant system according to the invention furthermore comprises a container closure, which closes the container opening in a fluidtight manner.

The connection between the container closure and the sealant container is advantageously not restricted in respect of its specific configuration. In this context, an expedient sealant system according to the invention is one in which the container closure and the sealant container comprise mutually complementary connecting elements. One example in this context is a sealant system according to the invention wherein the container closure is connected to the sealant container via a screw closure, a bayonet joint or a plug joint, preferably via a screwed joint. Accordingly, there is also a preference for a sealant system according to the invention wherein the container closure comprises a screw thread.

In most embodiments, it is expedient to design the closure as a reversibly and nondestructively releasable connection, e.g. in order to allow easy (re-)filling. In principle, however, it is also possible to configure the connection as a permanent connection that is not reversibly releasable, e.g. by means of a safeguard against unscrewing in order to prevent incorrect use of the sealant system or at least make it more difficult.

For all the above configurations, there is a preference for a sealant system according to the invention wherein a seal element, preferably a seal ring, is arranged between the container closure and the sealant container.

In the subsequent use of sealant systems according to the invention, a sealant arranged in the sealant system is delivered from the container opening of the sealant system through the previously sealing container closure by the action of external force. In many cases, especially in the tire repair sector, this action of an external force is effected or promoted by the introduction of another fluid, in particular compressed air. To enable this functionality, that is to say the introduction of a fluid and the discharge of the sealant, the container closure of the sealant system according to the invention comprises a specific fluid line system.

More specifically, according to the invention the container closure has a first fluid channel and a second fluid channel which, in the initial state, that is to say before use in a sealing process, are each closed in a fluidtight manner by a closure layer. In this context, in harmony with the understanding of those skilled in the art, a “closure layer” denotes a two-dimensionally extended, comparatively thin layer for closing an opening. According to the invention, the fluid channels extend through the container closure, and therefore, in the state in which it is closed by the container cap, the container interior would only be accessible via the first fluid channel and the second fluid channel if these were not closed by the closure layers.

In sealant systems according to the invention, this opening of the fluid channels is achieved by virtue of the fact that the closure layers are designed so that they break open under predetermined conditions.

According to the invention, the sealant system according to the invention is namely designed in such a way that the first closure layer in the first fluid channel is irreversibly destroyed at a first pressure difference, and the second closure layer in the second fluid channel is irreversibly destroyed at a second pressure difference, with the result that they each form a through-opening and allow fluid to pass through the respective fluid channel. As explained above, this enables a sealant arranged in the container interior to leave the sealant system according to the invention through one of the two fluid channels when compressed air is applied.

In the context of the present invention, the pressure difference acting between the two sides of the closure layer is taken to mean the absolute value of the difference of a pressure pB acting on the inside of the respective closure layer, that is to say usually in the container interior, and a pressure pr acting on the outside of the respective closure layer, that is to say usually in the fluid channel. In other words, this is therefore a sealant system according to the invention wherein the container closure closes the container opening in a fluidtight manner when the pressure difference between the pressure in the container interior and the ambient pressure is less than the first pressure difference and the second pressure difference.

In most cases, the sealant system according to the invention is operated in such a way in the subsequent sealing process that a sealant arranged in the container interior is forced out of the sealant container via one of the two fluid channels of the container closure when a gas pressure is applied, thus enabling it to be directed into the vehicle tire to be sealed, for example, via a further line. In practice, for example, compressed air can be introduced into the first fluid channel by means of a compressor, with the result that the first pressure difference is achieved and the first closure layer is accordingly destroyed. The compressed air introduced then displaces a sealant arranged in the container interior in such a way that the second pressure difference is also achieved and the second closure layer is destroyed, thus enabling the sealant to be introduced, e.g. via a hose, into the object to be sealed, e.g. a damaged vehicle tire. In other words, therefore, this is a sealant system according to the invention wherein the sealant system is configured to enable a working fluid to enter the container interior through the first fluid channel when the first through-opening and the second through-opening are formed, in order to displace a liquid arranged in the container interior out of the container interior through the second fluid channel.

In subsequent practice, it will in many cases be necessary to connect the outward-pointing ends of the first fluid channel and of the second fluid channel to fluid lines in order to carry fluids. For efficient connection of the fluid lines to the fluid channels, it is possible to use threaded connections, for example. Alternatively, hose connections are also conceivable, that is to say tube stubs to which a hose can be attached and optionally additionally secured by means of a hose clamp. There is therefore a preference for a sealant system according to the invention wherein the first fluid channel comprises a first connection for a fluid line, wherein the first connection preferably comprises a hose connection or a thread, preferably a thread. Additionally or alternatively, there is also a preference for a sealant system according to the invention wherein the second fluid channel comprises a second connection for a fluid line, wherein the second connection preferably comprises a hose connection or a thread, preferably a thread.

The sealant system according to the invention is advantageously not restricted in respect of the specific configuration of the fluid channels, wherein the dimensions and alignment thereof will in practice be chosen with reference especially to the dimensions of the container closure and the design configuration of the devices used in the sealing process. However, the inventors have to this extent identified dimensions which promote a particularly advantageous robustness of the sealant system according to the invention in relation to jolting and shocks and enable an excellent capacity for integration into typical sealing devices. More specifically, there is a preference for a sealant system according to the invention wherein the longitudinal axis of the first fluid channel and the longitudinal axis of the second fluid channel in the container closure form an angle of intersection in the range of from 45° to 135°, preferably in the range of from 60° to 120°, particularly preferably in the range of from 75° to 105°, very particularly preferably of substantially 90°. In the case of a right-angled alignment of the longitudinal axes of the fluid channels relative to one another, the inventors have found that the sealant system according to the invention is easier to handle in operation since this alignment of the fluid channels allows more efficient delivery of fluids, and the second fluid channel, in particular, is more easily accessible for the connection of an external fluid line.

In one example of a sealant system according to the invention, the first fluid channel has a length in the range of from 10 to 50 mm, preferably in the range of from 25 to 35 mm, and/or the first fluid channel has a mean diameter in the range of from 2 to 35 mm, preferably in the range of from 3 to 8 mm. Similarly, in one example of a sealant system according to the invention, the second fluid channel has a length in the range of from 10 to 50 mm, preferably in the range of from 15 to 25 mm, and/or the second fluid channel has a mean diameter in the range of from 2 to 35 mm, preferably in the range of from 3 to 8 mm.

The sealant system according to the invention can advantageously be adapted efficiently to a very wide variety of application requirements, thus making it possible, for example, to operate the sealant system according to the invention both upright and upside down. In other words, this means that the sealant system according to the invention can, if required, be designed in such a way that the sealant can be discharged both against gravity and with gravity. In an upright mode, that is to say when a sealant arranged in the container interior must be delivered at least in part against gravity in order to leave the sealant system through the container opening, it is necessary for this purpose to provide a “riser tube” on at least one of the fluid channels, namely the fluid channel through which the sealant is delivered. The term “riser tube” is clear to those skilled in the art in connection with fluids and denotes a tube or a hose through which pressurized fluids can rise. In contrast, when the sealant system according to the invention is operated upside down, that is to say when a sealant arranged in the container interior is delivered substantially with gravity, such a riser tube is not necessary for the fluid channel provided as the outlet. For subsequent upright use, therefore, there is a preference for a sealant system according to the invention wherein the second fluid channel is designed as a riser tube, wherein that end of the second fluid channel which points in the direction of the container interior preferably extends by 0.85*H or more, preferably by 0.9*H or more, particularly preferably by 0.95*H or more, into the container interior, wherein H is the height of the container interior.

For subsequent upside down use, there is a preference for a sealant system according to the invention wherein that end of the second fluid channel which points in the direction of the container interior extends by 0.15*H or less, preferably by 0.1*H or less, particularly preferably by 0.05*H or less, into the container interior, wherein that end of the first fluid channel which points in the direction of the container interior preferably extends by 0.05*H or more, particularly preferably by 0.1*H or more, very particularly preferably by 0.15*H or more, into the container interior, wherein H is the height of the container interior.

Even if, at least in theory, certain excess pressure safeguards may also be provided, it is expedient for substantially all the embodiments, in the estimation of the inventors, if the first fluid channel and the second fluid channel are completely separated from one another spatially and thus, in other words, cannot be short-circuited with one another. There is accordingly a preference in the case of substantially all the embodiments for a sealant system according to the invention wherein the first fluid channel and the second fluid channel are separated from one another in the container closure. There is likewise a preference for a sealant system according to the invention wherein the container closure is configured to prevent any fluid from passing out of the first fluid channel into the second fluid channel after the formation of the first through-opening and the second through-opening in the interior of the container closure.

As explained above, the sealant system according to the invention comprises, in each of the fluid channels, at least one closure layer, which prevents fluid passing through the respective fluid channel unless a specific pressure difference is exceeded. The inventors have recognized that there is fundamentally a free choice as regards the position of the closure layer within the respective fluid channel but that specific positions which minimize the risk of unwanted opening, due to external jolting for example, and at the same time enable reliable opening in subsequent use can be selected for the closure layers. More specifically there is a preference for a sealant system according to the invention wherein the first closure layer is arranged in the end region of the first fluid channel, preferably the end region pointing in the direction of the container interior, wherein the end region extends over 10% or less, preferably 5% or less, particularly preferably 2% or less, of the length of the first fluid channel, wherein the first closure layer is preferably arranged precisely at the end of the first fluid channel. In addition or as an alternative, there is also a preference for a sealant system according to the invention wherein the second closure layer is arranged in the end region of the second fluid channel, preferably the end region pointing in the direction of the container interior, wherein the end region extends over 10% or less, preferably 5% or less, particularly preferably 2% or less, of the length of the second fluid channel, wherein the second closure layer is preferably arranged precisely at the end of the second fluid channel.

Having regard to the conflict of aims arising from maximum safety of handling and excellent leaktightness, even under adverse environmental conditions, on the one hand, and easy and reliable opening in the sealing process, on the other hand, the inventors have identified particularly suitable ranges for the first pressure difference and the second pressure difference. In practice, it has thereby been possible to obtain particularly robust sealant systems which were nevertheless able to demonstrate reliable opening of the closure layers when the specific pressure difference ranges are reached. There is therefore a preference for a sealant system according to the invention wherein the first pressure difference is in the range from 50 to 400 kPa, preferably in the range of from 100 to 300 kPa, particularly preferably in the range of from 150 to 250 kPa, and/or wherein the second pressure difference is in the range from 50 to 400 kPa, preferably in the range of from 100 to 300 kPa, particularly preferably in the range of from 150 to 250 kPa.

As explained above, according to the invention the closure layers are each configured to be irreversibly destroyed at a specific pressure difference acting on them. Accordingly, the dimensions of the closure layers, in particular the mean thickness thereof, will depend substantially on the desired pressure difference and the respectively selected material and will be chosen accordingly by a person skilled in the art. In the estimation of the inventors, an expedient sealant system according to the invention for most materials is one in which the first closure layer has a mean thickness in the range of from 0.01 to 0.2 mm, preferably in the range of from 0.02 to 0.05 mm, and/or wherein the second closure layer has a mean thickness in the range of from 0.01 to 0.2 mm, preferably in the range of from 0.02 to 0.05 mm.

Fundamentally, neither the sealant container nor the container closure are subject to particular restrictions in respect of the materials used for their production. However, it may be regarded as a major advantage of the sealant systems according to the invention that the container closures can be efficiently formed in one piece and, in particular, can be produced in a particularly time-and cost-efficient way by injection molding. Accordingly, there is a preference in the case of substantially all the embodiments to form at least the container closures from a thermoplastic which is easy to process in corresponding injection molding methods, with advantages in terms of process engineering being obtained especially through the use of complementary plastics for the sealant container. Accordingly, there is a preference for a sealant system according to the invention wherein the container closure consists of 90% or more, preferably 95% or more, particularly preferably 98% or more, very particularly preferably substantially entirely, of a first thermoplastic, based on the mass of the container closure. There is furthermore a preference for a sealant system according to the invention wherein the sealant container consists of 90% or more, preferably 95% or more, particularly preferably 98% or more, very particularly preferably substantially entirely, of a third thermoplastic, based on the mass of the sealant container.

The inventors have thus succeeded in identifying materials with which it has been possible in practice to obtain particularly stable sealant systems and with which, in particular, it has also been possible to achieve reliable leaktightness, even under challenging environmental conditions, in combination with excellent production properties. More specifically, there is a preference for a sealant system according to the invention wherein the first thermoplastic is selected from the group comprising polyesters and polyolefins, preferably selected from the group comprising polyolefins, particularly preferably selected from the group comprising polyethylene and polypropylene, very particularly preferably selected from the group comprising polypropylene. More specifically, in addition or as an alternative, there is also a preference for a sealant system according to the invention wherein the third thermoplastic is selected from the group comprising polyesters and polyolefins, preferably selected from the group comprising polyolefins, particularly preferably selected from the group comprising polyethylene and polypropylene, very particularly preferably selected from the group comprising polypropylene.

Having regard to particularly time-and cost-efficient production of sealant systems according to the invention, the inventors propose, proceeding from the above considerations, that it is advantageous to form the closure layers from the same material as the container closure. In particularly preferred embodiments, the closure layers can be embodied as an integral component of the container closure, this being preferred for all the embodiments in the estimation of the inventors. Advantageously, in this embodiment, not only are the production steps required for manufacture reduced, that is to say, in particular, by avoiding subsequent production of the closure layers in the container closure, but also the mechanical stability of the container closure is increased. Accordingly, there is a preference for a sealant system according to the invention wherein the first closure layer and/or the second closure layer, preferably the first closure layer and the second closure layer, consist of the first thermoplastic, wherein the first closure layer and/or the second closure layer, preferably the first closure layer and the second closure layer, are connected materially to the rest of the container closure without a boundary layer, wherein the container closure is preferably formed in one piece, preferably in an injection molding process.

Alternatively, at least one of the closure layers can be manufactured from a material that is different from the container closure. In this case, however, the outlay in terms of manufacturing technology will generally be higher. Nevertheless, there is wider selection of materials available in this embodiment for the corresponding closure layer or for both closure layers, thus enabling closure layers to be adapted more effectively to application-specific requirements, e.g. to the pressure difference required for irreversible destruction. As an alternative, therefore, there is a preference for a sealant system according to the invention wherein the first closure layer and/or the second closure layer, preferably the first closure layer and the second closure layer, consist of a second thermoplastic, wherein the first closure layer and/or the second closure layer, preferably the first closure layer and the second closure layer, are connected materially to the rest of the container closure, preferably by fusing the first thermoplastic with the second thermoplastic. In this context, it is possible, for example, to conceive of a sealant system according to the invention wherein the second thermoplastic is selected from the group comprising polyesters and polyolefins, preferably selected from the group comprising polyolefins, particularly preferably selected from the group comprising polyethylene and polypropylene, very particularly preferably selected from the group comprising polypropylene.

Fundamentally, the generation of the pressure differences required to break open the closure layers in the subsequent sealing process can be accomplished in various ways, e.g. mechanically or by the introduction of additional fluids, in particular compressed air. The exertion of mechanical pressure can be accomplished, for example, by connecting the first fluid channel and/or the second fluid channel to some other component, e.g. a fluid line of a sealing device, e.g. with the respective closure layer being opened by a projection which is integrated into the other component and which exerts mechanical pressure on the closure layer during connection. However, there is advantageously no need for such additional components in the sealant systems according to the invention since the breaking open of the closure layers can be accomplished particularly easily and reliably through the action of a fluid-mediated pressure, that is to say by introducing a fluid, e.g. compressed air, into at least one of the fluid channels. The preference in the case of substantially all the embodiments is therefore for a sealant system according to the invention wherein the container closure is configured so that the first through-opening and/or the second through-opening, preferably the first through-opening and the second through-opening, are formed as a result of a pressure exerted by a fluid. The sealant system according to the invention reveals its advantages particularly in situations in which, owing to the technical circumstances, there is at least one pressure generating unit, e.g. an air compressor, available. Accordingly, there is also a preference for a sealant system according to the invention wherein the sealant system is configured so that the first through-opening and the second through-opening can be formed by the application of a gas pressure to the first fluid channel or the second fluid channel, preferably a gas pressure generated by a pressure generating unit.

A person skilled in the art will understand that the invention furthermore relates to a container closure for the fluidtight closure of a container opening of a sealant container in a sealant system according to the invention,
wherein the container closure comprises a first fluid channel extending through the container closure, wherein the first fluid channel is closed by a first closure layer, by which fluid is prevented from escaping out of the closed container opening through the first fluid channel,
wherein the container closure comprises a second fluid channel extending through the container closure, wherein the second fluid channel is closed by a second closure layer, by which fluid is prevented from escaping out of the closed container opening through the second fluid channel,
wherein the container closure is configured such that the first closure layer is irreversibly destroyed and forms a first through-opening, which makes it possible for fluid to pass through the first fluid channel, as the result of a first pressure difference, in the range from 50 to 1000 kPa, acting between the sides of the first closure layer, and
wherein the container closure is configured such that the second closure layer forms a second through-opening, which makes it possible for fluid to pass through the second fluid channel, as the result of a second pressure difference, in the range from 50 to 1000 kPa, acting between the sides of the second closure layer.

The invention furthermore relates to a method for producing a sealant system according to the invention or a container closure according to the invention, comprising the following method steps:
i) producing or providing a first thermoplastic, and
ii) molding the container closure blank from the first thermoplastic in a molding process,
wherein the first closure layer and the second closure layer are molded independently of one another in method step ii), each as part of the container closure blank or after injection of a second thermoplastic into the container closure blank.

The method according to the invention for producing the sealant system according to the invention or the container closure according to the invention comprises producing or providing a first thermoplastic in a first method step, and molding the container closure blank from this first thermoplastic in a molding process in a second method step, wherein various suitable molding methods are known to those skilled in the art. There is a preference here for a method according to the invention wherein the molding method is an injection molding method.

According to the invention, the closure layers are molded either as a component of the container closure blank or -as a slightly less preferred option molded subsequently by introducing a second thermoplastic into the container closure blank. In principle, the two closure layers are molded independently of one another, that is to say, for example, only in one case being molded by subsequent introduction of the closure layer. However, there is a preference for a method according to the invention wherein the first closure layer and the second closure layer are formed in the same way in method step ii).

Having regard to the particularly advantageous one-piece formation of the container closures and particularly time-and cost-efficient production of the sealant system according to the invention and of the container closure according to the invention, there is furthermore a preference for a method according to the invention wherein the first closure layer and the second closure layer are molded independently of one another, in each case as part of the container closure blank, in method step ii).

The inventors have recognized that, in the method according to the invention, the leaktightness of the sealant system according to the invention and of the container closure according to the invention can advantageously be checked directly during the production process. To this end, preference is given to a method according to the invention additionally comprising the following method step:
iii) checking the fluidtightness of the first fluid channel by applying a first test pressure difference and of the second fluid channel by applying a second test pressure difference, wherein the first test pressure difference is smaller than the first pressure difference and wherein the second test pressure difference is smaller than the second pressure difference, preferably in each case by 10% or more, particularly preferably by 20% or more.

In the context of the invention, there is also a disclosure of a puncture repair kit comprising:
aa) one or more sealant systems according to the invention comprising a sealant in the container interior, and
bb) a pressure generating unit.

In harmony with the understanding of a person skilled in the art, a puncture repair kit is taken to mean a kit comprising a number of units which, when used, may enable the at least temporary sealing of a defective vehicle tire. It is thus possible, for example, for a vehicle with a defect that has been eliminated by means of the puncture repair kit to continue driving independently, at least for a certain time, e.g. to enable a repair garage to be found for the exchange or repair of the vehicle tire affected, thereby in particular eliminating the need for a vehicle recovery service. For this purpose, the puncture repair kit comprises at least one sealant system according to the invention with sealant and a pressure generating unit. A puncture repair kit as disclosed above is appropriate for most applications, wherein the pressure generating unit is an air compressor.

The puncture repair kit disclosed is suitable, in particular, for sealing damage caused by relatively small objects, such as nails.

To connect the pressure generating unit to the at least one sealant system and to connect the sealant system to the object to be sealed, fluid lines, e.g. connecting hoses, are generally used in practice. Accordingly, an expedient option for most embodiments is a puncture repair kit of the kind disclosed above, additionally comprising:
cc) one or more fluid lines, preferably hoses, for connecting the sealant system to a vehicle tire and/or to the pressure generating unit.

In practice, another expedient option is a puncture repair kit of the kind disclosed above, additionally comprising:
dd) operating instructions for sealing a damaged vehicle tire using the puncture repair kit.

Also disclosed is a method for sealing a damaged vehicle tire using a puncture repair kit according to the invention, comprising the following steps:
v) producing a fluidic connection between the first fluid channel and the pressure generating unit,
w) producing a fluidic connection between the second fluid channel and the pressure valve of the damaged vehicle tire,
x) generating an excess pressure in the first fluid channel by means of the pressure generating unit so as to generate a first operating pressure difference between the sides of the first closure layer, wherein the first operating pressure difference is greater than or equal to the first pressure difference, in order to form the first through-opening in the first closure layer,
y) generating an excess pressure in the container interior by means of the pressure generating unit so as to generate a second operating pressure difference between the sides of the second closure layer, wherein the second operating pressure difference is greater than or equal to the second pressure difference, in order to form the second through-opening in the second closure layer, and
z) discharging the sealant from the sealant system through the second fluid channel into the damaged vehicle tire.

Preferred embodiments of the invention will be explained and described in more detail hereunder with reference to the appended figures. In the figures:

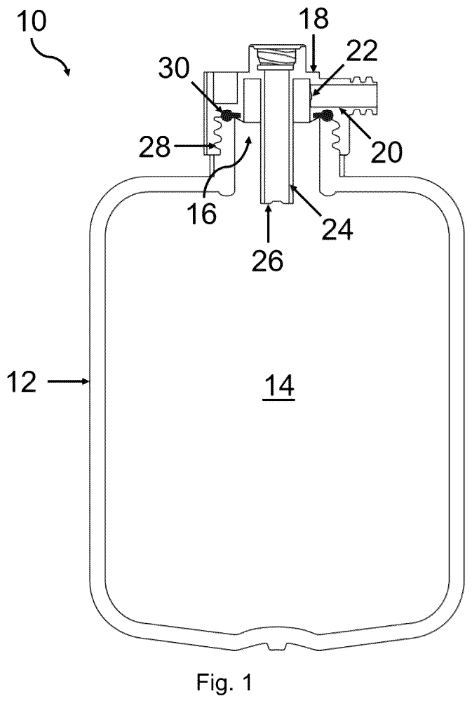

FIG. 1 shows a schematic cross-sectional illustration of a sealant system according to the invention in a preferred embodiment; and

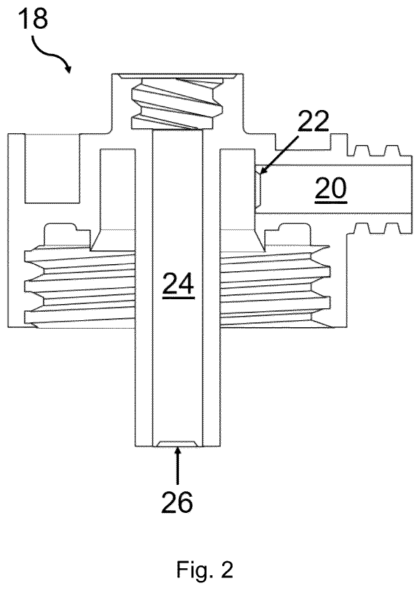

FIG. 2 shows a schematic cross-sectional illustration of a container closure according to the invention in a preferred embodiment.

FIG. 1 shows a sealant system 10 according to the invention comprising a sealant container 12 and a container closure 18.

In the example shown, the sealant container 12 has a container interior 14 with a volume of about 0.45 1, in which a sealant can be enclosed in a fluidtight manner if the container closure 18 is screwed in a reversible and nondestructively releasable manner to the container opening 16 of the sealant container 12 by means of a corresponding screw thread 28. Leaktightness is additionally promoted by means of a seal element 30, which is arranged between the screw thread 28 of the container opening 16 and the container closure 18. In the example shown, both the sealant container 12 and the container closure 18 are manufactured from polypropylene.

As also shown on an enlarged scale in FIG. 2, the container closure 18 has a first fluid channel 20 and a second fluid channel 24, the longitudinal axes of which are arranged orthogonally to one another in the container closure 18 in such a way that fluid cannot pass out of the first fluid channel 20 into the second fluid channel 24. At their end pointing away from the container interior 14, each of the two fluid channels has a thread for connection of a fluid line, in particular for the connection of hoses.

At its end pointing toward the container interior 14, the first fluid channel 20 furthermore comprises a first closure layer 22 with a mean thickness of about 0.05 mm. At its end pointing toward the container interior 14, the second fluid channel 24 comprises a second closure layer 26 with a mean thickness of about 0.05 mm.

In the example shown, the container closure 18 is designed in such a way that, when a first pressure difference of 250 kPa acting between the sides of the first closure layer 22 is applied, and in consequence of a second pressure difference of 250 kPa acting between the sides of the second closure layer 26, the respective closure layer is irreversibly destroyed and, in the process, a first through-opening and a second through-opening are formed, thus allowing fluid to pass through the first fluid channel 20 and the second fluid channel 24. In other words, the container closure 18 closes the container opening 16 in FIG. 1 fluidtightly until the pressure difference between the pressure in the container interior 14 and the ambient pressure is greater than the first pressure difference or the second pressure difference.

In the example shown, the container closure 18 is designed in such a way that the closure layers can each be destroyed as a consequence of a gas pressure generated by an air compressor, wherein the working fluid can enter the container interior 14 through the second fluid channel 24 in order to displace a sealant arranged in the container interior 14 from the container interior 14 through the first fluid channel 20, wherein the sealant system 10 shown is designed for use upside down.

In the preferred container closure 18 shown, both closure layers are produced in an injection molding process from the same material as the rest of the container closure 18 and, in this process, have been produced in such a way that they are connected materially to the rest of the container closure 18, without a boundary layer, and therefore the container closure 18 is of one-piece design overall.

### LIST OF REFERENCE SIGNS

10 Sealant system
12 Sealant container
14 Container interior
16 Container opening
18 Container closure
20 First fluid channel
22 First closure layer
24 Second fluid channel
26 Second closure layer
28 Screw thread
30 Seal element

1. A sealant system, comprising:
a) a sealant container, comprising a container interior for holding sealant, wherein the container interior is accessible via a container opening, and
b) a container closure,
wherein the container closure closes the container opening in a fluidtight manner,
wherein the container closure comprises a first fluid channel extending through the container closure, wherein the first fluid channel is closed by a first closure layer, by which fluid is prevented from escaping out of the container opening through the first fluid channel,
wherein the container closure comprises a second fluid channel extending through the container closure, wherein the second fluid channel is closed by a second closure layer, by which fluid is prevented from escaping out of the container opening through the second fluid channel,
wherein the container closure is configured such that the first closure layer is irreversibly destroyed and forms a first through-opening, which makes it possible for fluid to pass through the first fluid channel, as the result of a first pressure difference, in the range from 50 to 1000 kPa, acting between the sides of the first closure layer, and
wherein the container closure is configured such that the second closure layer forms a second through-opening, which makes it possible for fluid to pass through the second fluid channel, as the result of a second pressure difference, in the range from 50 to 1000 kPa, acting between the sides of the second closure layer

2. The sealant system as claimed in claim 1, wherein the first pressure difference is in the range from 50 to 400 kPa, and/or wherein the second pressure difference is in the range from 50 to 400 kPa.

3. The sealant system as claimed in claim 1, wherein the container closure is configured so that the first through-opening and/or the second through-opening are/is formed as a result of a pressure exerted by a fluid.

4. The sealant system as claimed in one of claims 1 to 3, additionally comprising a sealant in the container interior.

5. The sealant system as claimed in claim 1, wherein the container closure consists of 90% or more of a first thermoplastic, based on the mass of the container closure, wherein the first closure layer and/or the second closure layer consist/consists of the first thermoplastic.

6. The sealant system as claimed in claim 1, wherein the first closure layer and/or the second closure layer are connected materially to the rest of the container closure without a boundary layer.

7. The sealant system as claimed in claim 1, wherein the second fluid channel is designed as a riser tube, or wherein that end of the second fluid channel which points in the direction of the container interior extends by 0.15*H or less into the container interior wherein H is the height of the container interior.

8. The sealant system as claimed in claim 1, wherein the first closure layer is arranged in the end region of the first fluid channel, wherein the end region extends over 10% or less of the length of the first fluid channel, and/or wherein the second closure layer is arranged in the end region of the second fluid channel, wherein the end region extends over 10% or less of the length of the second fluid channel.

9. A container closure for the fluidtight closure of a container opening of a sealant container in a sealant system as claimed in claim 1,
wherein the container closure comprises a first fluid channel extending through the container closure wherein the first fluid channel is closed by a first closure layer, by which fluid is prevented from escaping out of the closed container opening through the first fluid channel,
wherein the container closure comprises a second fluid channel extending through the container closure, wherein the second fluid channel is closed by a second closure layer, by which fluid is prevented from escaping out of the closed container opening through the second fluid channel,
wherein the container closure is configured such that the first closure layer is irreversibly destroyed and forms a first through-opening, which makes it possible for fluid to pass through the first fluid channel, as the result of a first pressure difference, in the range from 50 to 1000 kPa, acting between the sides of the first closure layer, and
wherein the container closure is configured such that the second closure layer forms a second through-opening, which makes it possible for fluid to pass through the second fluid channel as the result of a second pressure difference, in the range from 50 to 1000 kPa, acting between the sides of the second closure layer.

10. A method for producing a sealant system as claimed in claim 1, comprising the following method steps:
i) producing or providing a first thermoplastic, and
ii) molding the container closure blank from the first thermoplastic in a molding process,
wherein the first closure layer and the second closure layer are molded independently of one another in method step ii), each as part of the container closure blank or after injection of a second thermoplastic into the container closure blank.
